(19) United States
(12) Patent Application Publication
(10) Pub. No.: US 2017/0136468 A1
(43) Pub. Date: May 18, 2017

(54) BREAKER TOOTH AND DRUM ASSEMBLY FOR A MINERAL BREAKER

(71) Applicant: MMD Design & Consultancy Limited, Somercotes (GB)

(72) Inventor: Richard BARBER, Alfreton (GB)

(73) Assignee: MMD Design & Consultancy Limited, Somercotes (GB)

(21) Appl. No.: 15/323,331

(22) PCT Filed: Jul. 3, 2015
(86) PCT No.: PCT/GB2015/051946

§ 371 Date: Dec. 30, 2016

(30) Foreign Application Priority Data
Jul. 4, 2014 (GB) 1412012.5

(51) Int. Cl. B02C 4/30

(52) U.S. Cl. CPC B02C 4/305; B02C 2210/02

(57) ABSTRACT

A breaker tooth assembly for a mineral breaker, a drum assembly including such a breaker tooth assembly and a mineral breaker with such a breaker tooth assembly or drum assembly are described. The breaker tooth assembly including a horn protrusion extending from a rotatable support, the horn protrusion having a pair of opposed front and rear faces; and a shell structure encapsulating the horn protrusion and defining the outer shape of the breaker tooth; wherein the shell structure comprises a plurality of covers which are non-releasably secured to one another, but not to the horn protrusion, to define a unitary breaker tooth assembly; and wherein at least one cover of the shell structure is releasably connectable with a corresponding face of the horn protrusion.

The present invention relates to a breaker tooth assembly for a mineral breaker; and to a drum assembly for a mineral breaker. The invention is primarily, though not exclusively, concerned with breaker tooth assemblies and drum assemblies for use with mineral breakers of the general type disclosed in the applicant's European patent No. EP0167178.

In this type of mineral breaker, mineral lumps of various size, hardness and material type are broken down into smaller pieces by gripping the lumps and applying tensile forces to cause the lump to break in a snapping action. In this type of mineral breaker, each ‘breaker tooth’ is repeatedly exposed to large breaking forces sequentially applied onto the front and rear of the tooth portion respectively.

In order to enable each breaker tooth to withstand such breaking forces it is desirable that they are constructed so as to have a core formed of a ductile metal covered with a tooth shell of a more brittle and wear resistant material. In order to be capable of breaking particularly hard minerals, e.g. granite, it is necessary to be able to transmit, from a drive shaft, relatively large forces.

The applicant has previously proposed a tooth construction for a mineral breaker in its international patent publication No. WO2005/046875 A1. Disclosed therein is a breaker tooth shell comprising a number of cover plates each of which are welded directly to an underlying horn protrusion extending from a drum annulus. Direct welding to the horn is advantageous insofar as it provides a means of securely fixing the breaker tooth shells in a manner which can withstand large impact forces. However, such an arrangement can be inconvenient or problematic when, after a period of use, it subsequently becomes necessary to remove a breaker tooth shell, e.g. in the event of a replacement shell being required due to wear. Indeed, in the arrangement disclosed in the aforementioned document, only a top cover portion of the breaker tooth shell can be readily removed and replaced by means of a gouging tool inserted into recess provided along a weld seam.

According to a first aspect of the present invention there is provided a breaker tooth assembly for a mineral breaker, the breaker tooth assembly including a horn protrusion extending from a rotatable support, the horn protrusion having a pair of opposed front and rear faces; and a shell structure encapsulating the horn protrusion and defining the outer shape of the breaker tooth; wherein the shell structure comprises a plurality of covers which are non-releasably secured to one another, but not to the horn protrusion, to define a unitary breaker tooth assembly; and wherein at least one cover of the shell structure is releasably connectable with a corresponding face of the horn protrusion.

Optionally, the releasable connection is provided by a protrusion, extending from said at least one cover and/or said corresponding face, receivable within a complementary recess provided in the corresponding cover and/or face.

In the context of the present invention, the phrase “non-releasably secured” as used above refers to a means of securing which can only be reversed by forcible and irreversible destructive methods, e.g. by gouging a weld seam. By contrast, the phrase “releasably connectable” used above refers to a means of connection which is readily reversible without resulting in destruction of the interconnected parts, e.g. in the manner of a dovetail type joint; a mortise and tenon type joint; or a dado joint.

Optionally, the horn protrusion has a pair of opposed side faces.

Optionally, the shell structure comprises first and second side covers adapted to overly the opposed side surfaces of the horn protrusion, the side covers being in face to face contact with the respective opposed side faces of the horn protrusion.

Optionally, the shell structure comprises an intermediate top cover adapted to overlie a top face of the horn protrusion, the intermediate top cover being in face to face contact with the top face of the horn protrusion.

Optionally, the shell structure comprises an intermediate front cover adapted to overlie a front face of the horn protrusion, the intermediate front cover being in face to face contact with the front face of the horn protrusion.

Optionally, an aperture is provided in the intermediate front cover for permitting access to a recess formed in the front face of the horn protrusion.

Optionally, the shell structure comprises an outer front cover provided with a protrusion dimensioned to pass through the aperture and seat within the recess within the front face of the horn protrusion.

Optionally, the outer front cover is non-releasably secured to the intermediate front cover.

Optionally, two or more of the side, intermediate top and intermediate front covers are formed integrally as a sub-assembly of the shell structure.

Additionally or alternatively, two or more of the side, top and intermediate front covers are non-releasably secured together to form a sub-assembly of the shell structure.

Optionally, the shell structure comprises an outer top cover non-releasably secured to the underlying intermediate top cover.

Optionally, the shell structure comprises a rear cover provided with a protrusion dimensioned to seat within a recess formed in the rear face of the horn protrusion.

Optionally, the rear cover is non-releasably secured to edges of one or more other covers for example to one or more of the top cover(s) and/or the first and second side covers, or alternatively for example where top cover(s) and/or first and second side covers are not present, the rear cover is non-releasably secured to a top face and/or the first and second side faces of the horn protrusion.

Optionally, a breaking tip member is non-releasably secured to the shell structure.

Optionally, the means of non-releasable securing is welding and a breaking tip member is welded to the shell structure.

It will be appreciated that whilst a weld seam can be removed, this can only be achieved forcibly, e.g. by a gouging tool as mentioned above.

According to a second aspect of the invention there is provided a mineral breaker including a breaker tooth assembly according to the first aspect.

According to a third aspect of the invention there is provided a drum assembly for a mineral breaker, the drum assembly including a plurality of toothed annuli mounted on a drive shaft, each annulus having a plurality of breaker tooth assemblies according to the first aspect spaced about its circumference.

According to a fourth aspect of the invention there is provided a mineral breaker including a drum assembly according to the third aspect.

Embodiments of the present invention will now be described, by way of example only, with reference to the accompanying drawings, in which:

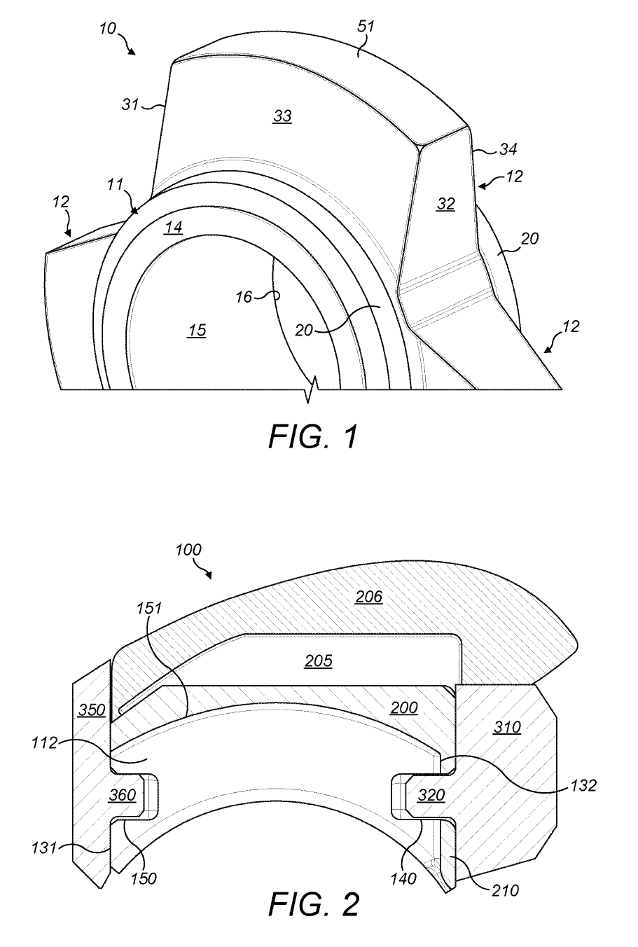

FIG. 1 is a part perspective view of a prior art drum annulus and horn protrusion;

FIG. 2 is a part cross-sectional view of a horn protrusion and associated shell structure according to the present invention;

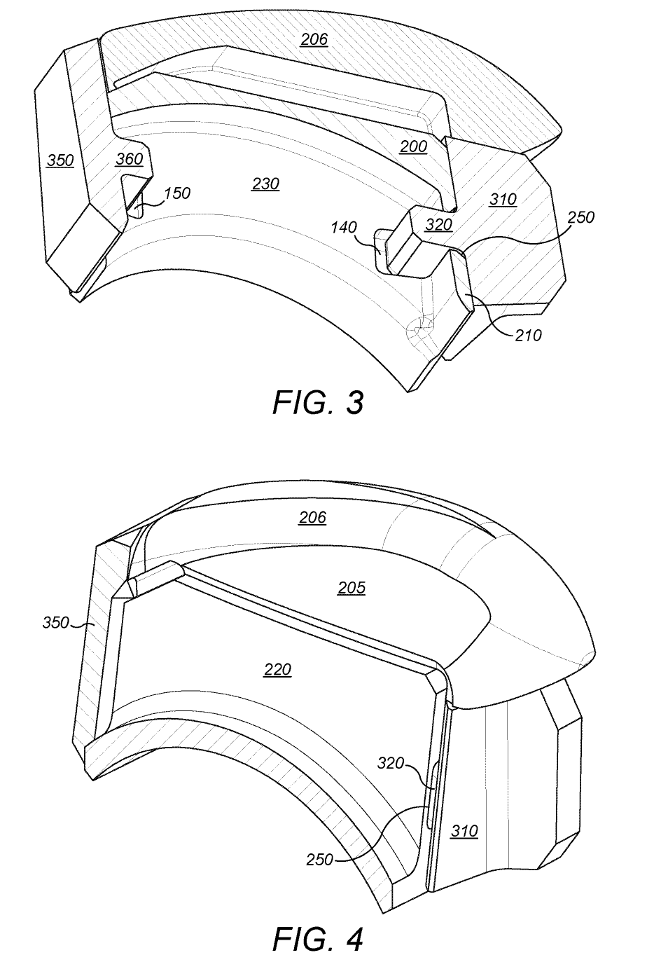

FIG. 3 is a part perspective view of the arrangement of FIG. 2 minus the horn protrusion revealing the inner surfaces of the side cover and parts of the intermediate front and top covers;

FIG. 4 is a part perspective view of the shell structure according to the present invention when assembled over the horn protrusion;

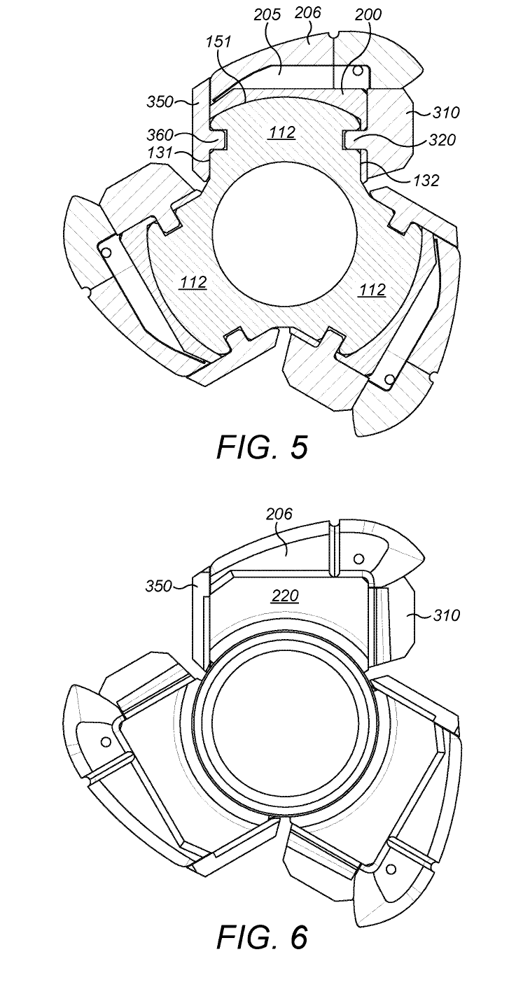

FIG. 5 is a cross-sectional view of a drum annulus according to the present invention comprising three circumferentially spaced breaker tooth assemblies;

FIG. 6 is a side view of the drum annulus of FIG. 5 showing the shell structure assembled over the horn protrusion;

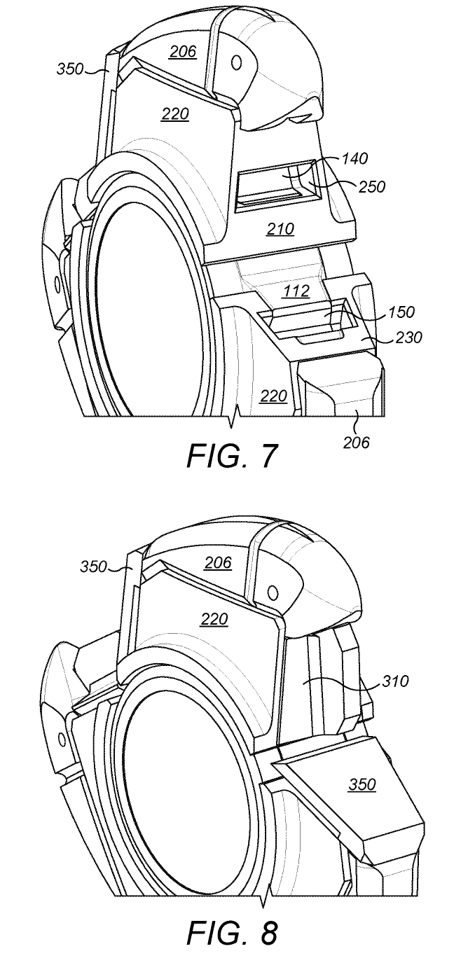

FIG. 7 is a part perspective view of the drum annulus of FIGS. 5 and 6 showing the shell structure minus its outer front cover; and

FIG. 8 is a part perspective view of the drum annulus of FIGS. 5 and 6 showing the complete shell structure encapsulating the underlying horn protrusion.

Referring initially to FIG. 1, there is illustrated a known drum annulus 10 having an annular boss 11 from which a plurality of horn protrusions 12 project radially. The annulus 10 is illustrated as having four horn protrusions 12 spaced about its circumference (one of the horns not being shown). It is envisaged that the number of horn protrusions 12 may be greater or less than four; typically the number of horn protrusions 12 would be in the range of three to eight.

The horn protrusions 12 have a width in the axial direction which is less than the axial width of the annular boss 11 and are centrally located relative to the axial end faces 14, 16 of the boss 11. Accordingly, on both sides of the row of horns 12 the boss 11 defines an annular shoulder 20. Each horn protrusion is provided with a rear face 31 a front face 32, side faces 33, 34 and a top face 51.

The drum annulus 10 includes a through bore 15 which, in use, enables the annulus 10 to be slid onto a drive shaft. To construct a drum assembly for a mineral breaker, several drum annuli 10 are slid onto a drive shaft and each annulus 10 is fixedly secured to the shaft so as to be rotatable therewith.

Each annulus 10 can be secured to the draft shaft by welding. This is conveniently achieved by exposing a portion of the shaft between adjacent annuli and welding the annuli to the exposed portion of the shaft. Preferably the exposed portions of the shaft are defined by axially spacing opposed end faces 14, 16 of adjacent annuli and filling the resultant gap with weld. The annulus 10 may be forged in one piece from a suitable metal such that the boss 11 and horn protrusions 12 are integrally formed.

Referring to FIGS. 2 to 8 illustrating embodiments in accordance with the present invention, a modified drum annulus 100 is provided employing a horn protrusion 112 in which recesses 140, 150 are formed in its front and rear faces 131, 132. The recesses take the form of rectangular cut outs extending horizontally across the full width of the front and rear faces as is most clearly visible in FIGS. 2 and 7. In the example shown, the recesses are positioned approximately midway between the uppermost and lowermost extremities of the front and rear faces 131, 132 of the horn protrusion 112.

The shell structure may be attached to the horn protrusion 112 in the following manner. Firstly, the shell structure sub-assembly comprising of intermediate top 200, intermediate front 210 and side covers 220, 230 is positioned over the horn protrusion 112 such that the inner surfaces of each cover contact and align respectively with the corresponding top face 151, front face 152 and side faces of the horn protrusion 112. In doing so, an aperture 250 in the intermediate front cover is aligned with the recess 140 in the front face 132 of the horn protrusion 112. The aperture 250 is oversized in the width direction relative to the width of the horn protrusion 112 as best shown in FIG. 7. As shown in FIGS. 3, 4 and 7, the lateral extremities of the aperture 250 extend into recessed portions provided in the side faces.

An outer front cover 310 is provided with a rectangular shaped protrusion 320 dimensioned such that it may extend through the aperture 250 and be removably seated within the complementary recess 140 formed within the front face 132 of the horn protrusion 112. The outer front cover 310 may be secured to the intermediate front cover 210 and/or to the intermediate top cover 200 by welding.

Similarly, a rear cover 350 is also provided with a rectangular shaped protrusion 360 dimensioned such that it may extend through the aperture 150 and be removably seated within the complementary recess 150 formed within the rear face 131 of the horn protrusion 112. The rear cover 350 may be secured to edges of the top cover(s) 200 and the first and second side covers 220, 230 by welding.

Finally, an outer top cover 205, 206—which may be formed as one or two part—is mounted over the intermediate top cover 200. The outer top cover(s) 205, 206 may be secured to the intermediate top cover 200, the intermediate front cover 210 and the outer front cover 310 by welding.

The above arrangement produces a breaker tooth in which a horn protrusion 112 is provided which is completely enclosed by a fabricated shell assembly. The shell assembly is attached in-situ onto the horn protrusion 112, preferably by welding, or otherwise non-removably fixing, its various covers 200, 210, 220, 230, 205, 206, 310, 350 to one another, Importantly, none of the covers are non-removably fixed to the horn protrusion itself. Instead, only the outer front and rear covers 310, 350 are passively and releasably connected to the corresponding faces 131, 132 of the horn protrusion 112. In the non-limiting example shown in the Figs, the protrusions 320, 360 fit within the recesses 140, 150 in a manner analogous to a dado woodworking joint. However, it will be appreciated that other shapes of protrusions and recesses are possible to form keyed joints, such as a dovetail type joint or a mortise and tenon type joint.

The arrangement of the present invention provides a very strong breaker tooth shell construction which is securely yet passively fixed to the horn protrusion 112 so as to be readily releasable therefrom. For example, to remove the entire shell assembly from the horn protrusion it is only necessary to release one or both of the outer front cover 310 or the rear cover 350 from the other cover members so that the relevant protrusions 320, 360 can be retracted out of the corresponding recess 140, 150. It will be appreciated that removal and replacement times can be greatly reduced by obviating the need to forcibly remove the shell assembly from the various surfaces of the horn protrusion, as is required in the prior art.

Modifications or improvements may be made to the foregoing without departing from the scope of the present invention as defined by the appended claims.

1. A breaker tooth assembly for a mineral breaker, the breaker tooth assembly comprising:
a horn protrusion extending from a rotatable support, the horn protrusion having a pair of opposed front and rear faces;
a shell structure encapsulating the horn protrusion and defining the outer shape of the breaker tooth;
wherein the shell structure comprises a plurality of covers which are non-releasably secured to one another, but not to the horn protrusion, to define a unitary breaker tooth assembly; and
wherein at least one cover of the shell structure is releasably connectable with a corresponding face of the horn protrusion.

2. A breaker tooth assembly as claimed in claim 1, wherein the releasable connection is provided by a protrusion, extending from said at least one cover and/or said corresponding face, receivable within a complementary recess provided in the corresponding cover and/or face.

3. A breaker tooth assembly as claimed in claim 1, wherein the horn protrusion has a pair of opposed side faces.

4. A breaker tooth assembly as claimed in claim 3, wherein the shell structure comprises first and second side covers adapted to overly the opposed side surfaces of the horn protrusion, the side covers being in face to face contact with the respective opposed side faces of the horn protrusion.

5. A breaker tooth assembly as claimed in claim 1, wherein the shell structure comprises an intermediate top cover adapted to overly a top face of the horn protrusion, the intermediate top cover being in face to face contact with the top face of the horn protrusion.

6. A breaker tooth assembly as claimed in claim 1, wherein the shell structure comprises an intermediate front cover adapted to overly a front face of the horn protrusion, the intermediate front cover being in face to face contact with the front face of the horn protrusion.

7. A breaker tooth assembly as claimed in claim 6, wherein an aperture is provided in the intermediate front cover for permitting access to a recess formed in the front face of the horn protrusion.

8. A breaker tooth assembly as claimed in claim 6, wherein the shell structure comprises an outer front cover provided with a protrusion dimensioned to pass through the aperture and seat within the recess within the front face of the horn protrusion.

9. A breaker tooth assembly as claimed in claim 8, wherein the outer front cover is non-releasably secured to the intermediate front cover.

10. A breaker tooth assembly as claimed in claim 5, wherein two or more of the side, intermediate top and/or and intermediate front covers are formed integrally as a sub-assembly of the shell structure.

11. A breaker tooth assembly as claimed in claim 5, wherein two or more of the side, top and/or and intermediate front covers are non-releasably secured together to form a sub-assembly of the shell structure.

12. A breaker tooth assembly as claimed in claim 5, wherein the shell structure comprises an outer top cover non-releasably secured to the underlying intermediate top cover.

13. A breaker tooth assembly as claimed in claim 1, wherein the shell structure comprises a rear cover provided with a protrusion dimensioned to seat within a recess formed in the rear face of the horn protrusion.

14. A breaker tooth assembly as claimed in claim 13, wherein the rear cover is non-releasably secured to edges of at least one of a top cover and a first or second side cover.

15. A breaker tooth assembly as claimed in claim 13, wherein the rear cover is non-releasably secured to at least one of a top face and a first or second side face of the horn protrusion.

16. A breaker tooth assembly as claimed in claim 1, wherein a breaking tip member is non-releasably secured to the shell structure.

17. A breaker tooth assembly as claimed in claim 1, wherein the non-releasable securing is welding.

18. A mineral breaker including a breaker tooth assembly according to claim 1.

19. A drum assembly for a mineral breaker, the drum assembly including a plurality of toothed annuli mounted on a drive shaft, each annulus having a plurality of breaker tooth assemblies according to claim 1 being spaced about its circumference.

20. A mineral breaker including a drum assembly according to claim 19.
